(19) United States
(12) Patent Application Publication
(10) Pub. No.: US 2019/0344519 A1
(43) Pub. Date: Nov. 14, 2019

(54) SHOE SOLE MOLDING DEVICE

(71) Applicant: POU CHEN CORPORATION, Chang Hwa Hsien (TW)

(72) Inventors: Shih-Chia LIN, Yuanlin City (TW); Po-Wei Tsao, Chang Hwa Hsien (TW); Chien-Jung Hung, Chang Hwa Hsien (TW); Chih-Hsien Lin, Chang Hwa Hsien (TW); Tsung-Wei Kuo, Changhua City (TW); Ju-Cheng Chen, Tainan City (TW); Hung-Wu Hsieh, Changhua County (TW); Shao-Wei Jen, Chang Hwa Hsien (TW)

(73) Assignee: POU CHEN CORPORATION, Chang Hwa Hsien (TW)

(21) Appl. No.: 16/108,597

(22) Filed: Aug. 22, 2018

(30) Foreign Application Priority Data
May 8, 2018 (TW) 107115605

(51) Int. Cl. B29D 35/00; B29C 33/06; B29D 35/12

(52) U.S. Cl. CPC B29D 35/0063; B29D 35/128; B29D 35/122; B29C 33/065

(57) ABSTRACT

A shoe sole molding device adapted for heating and molding a foamed material into a shoe sole includes a mold seat unit, a core unit, an induction heating unit and a coil unit. The core unit is disposed in a core receiving space of the mold seat unit, and defines a cavity for receiving the foamed material. The induction heating unit is disposed around the core unit, and has magnetic permeability greater than that of the core unit. The coil unit is disposed around the induction heating unit, and provides electromagnetic wave to induce heating in the induction heating unit to heat up the core unit and the foamed material.

### CROSS-REFERENCE TO RELATED APPLICATION

This application claims priority of Taiwanese Invention Patent Application No. 107115605, filed on May 8, 2018.

### FIELD

The disclosure relates to a molding device, and more particularly to a shoe sole molding device.

### BACKGROUND

Foam shoe soles that are characterized by shock absorption ability, softness, and light weight have been developed. Taiwanese Utility Model Patent No. 576329 discloses an apparatus for forming a foamed body from a foamable plastic material under pressure control, where tubular heating elements are used to perform direct heating on the mold. Such direct heating is disadvantageous in terms of heating speed and uniformity of temperature distribution, and heat may be transferred to other components that are in contact with the mold. The service life of these components may be reduced because of long term operation in high temperatures, thereby increasing the maintenance cost.

### SUMMARY

Therefore, an object of the disclosure is to provide a shoe sole molding device that may have a relatively high heating speed.

According to the disclosure, the shoe sole molding device adapted for heating and molding a foamed material into a shoe sole is provided to include a mold seat unit, a core unit, an induction heating unit and a coil unit. The mold seat unit defines a core receiving space. The core unit is disposed in the core receiving space and defines a cavity adapted for receiving the foamed material. The induction heating unit is disposed around the core unit, and has magnetic permeability greater than that of the core unit. The coil unit is disposed around the induction heating unit, and provides electromagnetic wave to induce heating in the induction heating unit to heat up the core unit and the foamed material.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view illustrating a first embodiment of the shoe sole molding device according to the disclosure;

FIG. 2 is a sectional view of the first embodiment;

FIG. 3 is a partial perspective view of the first embodiment;

FIG. 4 is a sectional view illustrating a second embodiment of the shoe sole molding device according to the disclosure;

FIG. 5 is an exploded perspective view illustrating a third embodiment of the shoe sole molding device according to the disclosure; and

FIG. 6 is a sectional view of the third embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

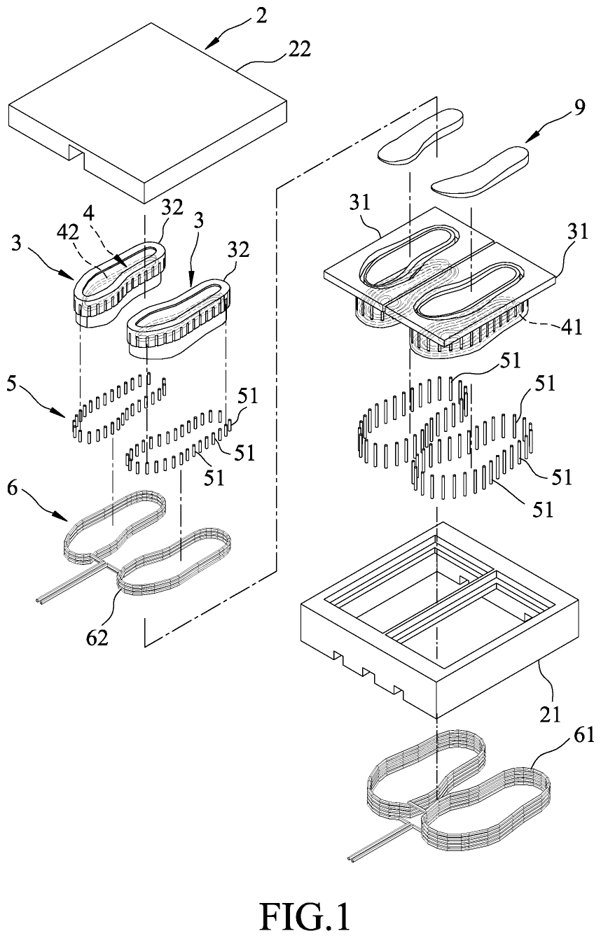

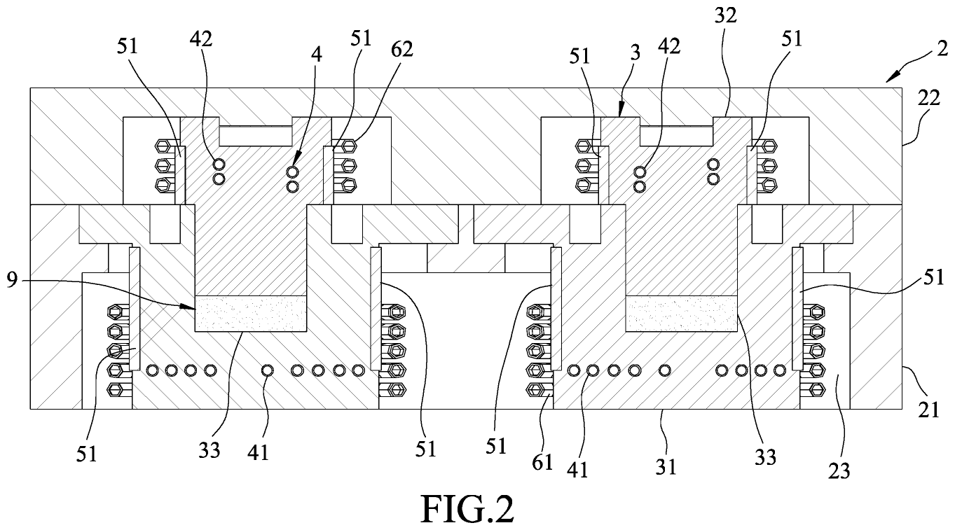

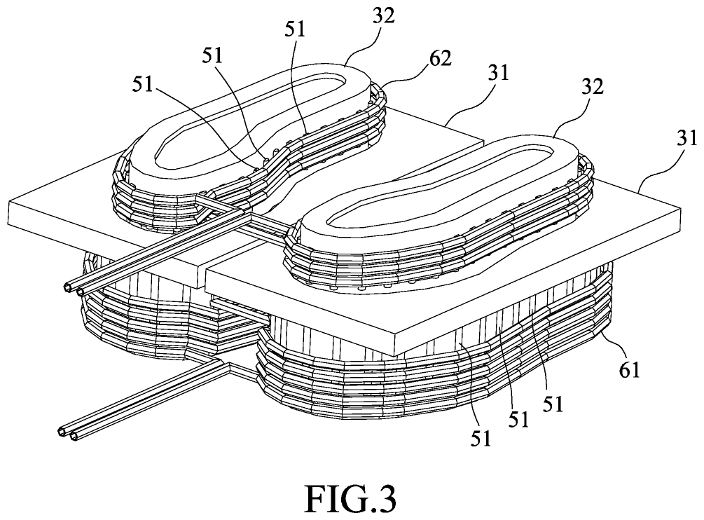

Referring to FIGS. 1 to 3, the first embodiment of the shoe sole molding device according to thi s disclosure is shown to include a mold seat unit 2, two core units 3, a temperature adjusting unit 4, an induction heating unit 5 and a coil unit 6. In this embodiment, the shoe sole molding device is adapted for a secondary press molding process for midsoles, which may be made using at least one of ethylene-vinyl acetate (EVA) or thermoplastic polyurethanes (TPU), but this disclosure is not limited in this respect.

It is noted that, the embodiments in this disclosure are, as exemplified, to produce a pair of midsoles, so two core units 3 are used, and the mold seat unit 2, the temperature adjusting unit 4, the induction heating unit 5 and a coil unit 6 are made to be adapted for producing a pair of midsoles . In other embodiments, only one or any plural number of the core units 3 may be used for producing the corresponding number of midsole(s) in cooperation with correspondingly designed mold seat unit 2, temperature adjusting unit 4, induction heating unit 5 and coil unit 6. It is noted that the shoe sole molding device of this embodiment is configured to produce a pair of the midsoles that respectively correspond to a left foot and a right foot, so it can be understood that the shoe sole molding device may have a symmetrical structure. Accordingly, only one core unit 3 and the corresponding structures of the temperature adjusting unit 4, the induction heating unit 5 and the coil unit 6 will be described hereinafter for the sake of brevity.

The mold seat unit 2 includes a lower mold seat 21 and an upper mold seat 22 that cooperatively define a core receiving space 23. The mold seat unit 2 is made using a material having low magnetic permeability, preferably having relative permeability smaller than 10. In one embodiment, the mold seat unit 2 is made of aluminum, of which the relative permeability is 1.

The core unit 3 is disposed in the core receiving space 23, and includes a lower core 31 mounted to the lower mold seat 21, and an upper core 32 mounted to the upper mold seat 22. The lower and upper cores 31, 32 cooperatively define a cavity 33 adapted for receiving a foamed material 9 to perform compression molding. The foamed material 9 refers to a blank that has been made by foaming, for example, the abovementioned EVA or TPU material, in a primary foaming and pressing process. It is noted that the core unit 3 is configured to be removably received in the core receiving space 23. In this embodiment, the core unit 3 is made of aluminum, but this disclosure is not limited in this respect.

The temperature adjusting unit 4 is configured to adjust temperature (e.g., cooling or heating) of the core unit 3, and includes a lower temperature adjusting module 41 disposed in the lower core 31, and an upper temperature adjusting module 42 disposed in the upper core 32. In this embodiment, each of the lower and upper temperature adjusting modules 41, 42 includes one or more pipes extending through the corresponding one of the lower core 31 and the upper core 32. In one embodiment, hot water or cold water may be injected into the pipes for heating or cooling the core unit 3. In one embodiment, the pipes may be electric heaters for heating the core unit 3.

The induction heating unit 5 is disposed around the core unit 3, and includes a plurality of induction heating members 51 divided into a lower member group and an upper member group that respectively surround the lower core 31 and the upper core 32, where each of the lower and upper member groups includes at least one induction heating member 51. Preferably, one or more of the induction heating members 51 surround the corresponding low or upper core 31, 32 at a location corresponding in position to the cavity 33. Preferably, each of the induction heating members 51 is one of bar-shaped and sheet-shaped, and the induction heating members 51 have a total volume smaller than that of the core unit 3.

The induction heating members 51 have magnetic permeability greater than that of the core unit 3 for better induction heating. Preferably, the induction heating members 51 have relative permeability greater than 10. In one embodiment, the induction heating members 51 may be made of JIS S45C carbon steel, which has relative permeability of 190 and which is relatively easy to be induced to generate eddy current. The core unit 3 has thermal conductivity greater than that of the induction heating members 51 for better thermal conduction. Preferably, the core unit 3 is made of a material having thermal conductivity greater than 50 W/(m·K), such as aluminum.

The coil unit 6 is disposed around the induction heating members 51, and is used to provide electromagnetic wave to induce heating in the induction heating members 51 to heat up the core unit 3, and in turn the foamed material 9. The coil unit 6 includes a lower coil 61 that surrounds the lower core 31, an upper coil 62 that surrounds the upper core 32, and a programmable logic controller (PLC, not shown) that is electrically coupled to the lower coil 61 and the upper coil 62. Preferably, the electromagnetic wave provided by the coil unit 6 is a high frequency electromagnetic wave that has a frequency ranging between 100 KHz and 300 MHz. Since the techniques for generation of the high frequency electromagnetic wave should be familiar to persons skilled in the art, details thereof are omitted herein for the sake of brevity.

The secondary press molding process for the midsole includes three stages: a heating stage, a temperature maintaining stage, and a cooling stage.

In the heating stage, the foamed material 9 (referring herein to a midsole blank that was formed after a primary foaming and pressing process) is placed in the cavity 33, and the coil unit 6 is provided with the high frequency signal to generate the e lectromagnetic wave for inducing eddy current in the induction heating unit 5 and the core unit 3, thereby heating up the same. In this embodiment, since the induction heating unit 5 is made of carbon steel which has large magnetic permeability and is bar-shaped or sheet-shaped with a small volume, the temperature thereof may rise rapidly. Since the core unit 3 is made of aluminum which has large thermal conductivity and small specific heat capacity, the core unit 3 may be heated by thermal conduction in addition to induction heating, so the temperature thereof may rise rapidly and uniformly. Moreover, hot water may be provided to the temperature adjusting unit 4 at this stage to further speed up the heating of the core unit 3.

In the temperature maintaining stage, the PLC may control time of heating by the high frequency electromagnetic wave, such as using pulse width modulation to control the high frequency current flowing through the coil unit 6, such that the temperature of the core unit 3 is maintained within a predetermined range.

In the cooling stage, cold water is provided to the temperature adjusting unit 4 for cooling the core unit 3, completing production of the midsole. In this embodiment, since the core unit 3 is made of aluminum and the total volume of the induction heating members 51 is smaller than that of the core unit 3, the induction heating members 51 may be rapidly cooled down by the core unit 3, thereby alleviating the drawback of carbon steel in the aspect of slow cooling due to its relatively small thermal conductivity and relatively large specific heat capacity.

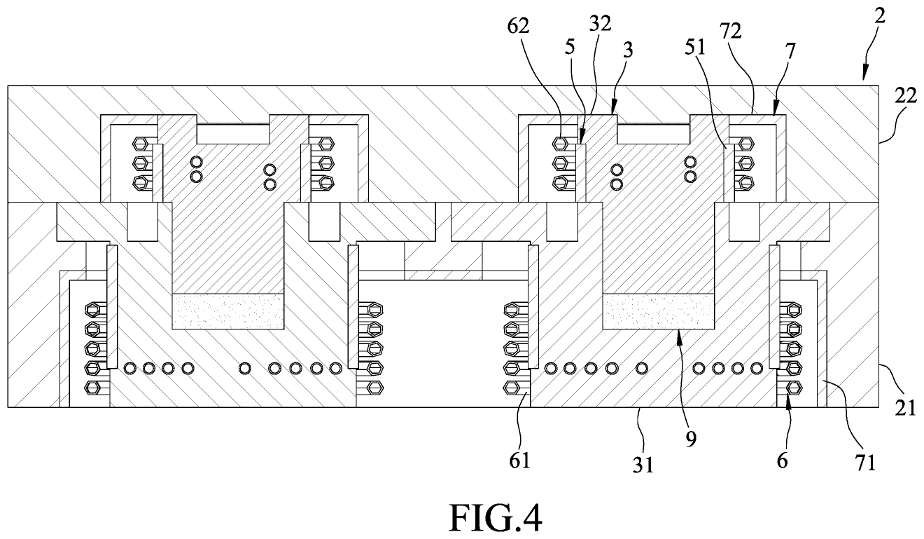

FIG. 4 shows the second embodiment of the shoe sole molding device according to this disclosure which is similar to the first embodiment, and differs from the first embodiment in that the second embodiment further includes a wave guiding unit 7. The wave guiding unit 7 is disposed between the mold seat unit 2 and the coil unit 6 for directing the electromagnetic wave provided by the coil unit 6 toward the core unit 3. The wave guiding unit 7 includes a lower wave guiding module 71 disposed between the lower mold seat 21 and the lower coil 61, and an upper wave guiding module 72 disposed between the upper mold seat 22 and the upper coil 62. Preferably, the lower and upper wave guiding modules 71, 72 are disposed to surround the lower and upper coils 61, 62, respectively, so as to direct the electromagnetic wave provided by the coil unit 6 toward the core unit 3.

The wave guiding unit 7 is made of a soft magnetic material (e.g., manganese-zinc ferrite, nickel-zinc ferrite, etc.) that can change a propagation direction of the electromagnetic wave, such that the electromagnetic wave that propagates toward the mold seat unit 2 is adjusted to propagate toward the core unit 3, thereby enhancing the induction heating of the induction heating unit 5 and also accelerating the heating of the core unit 3. Furthermore, the wave guiding unit 7 isolates the mold seat unit 2 from the induction heating unit 51 and the core unit 3, further lessening the temperature rise of the mold seat unit 2 that may cause damage to the components around the mold seat unit 2.

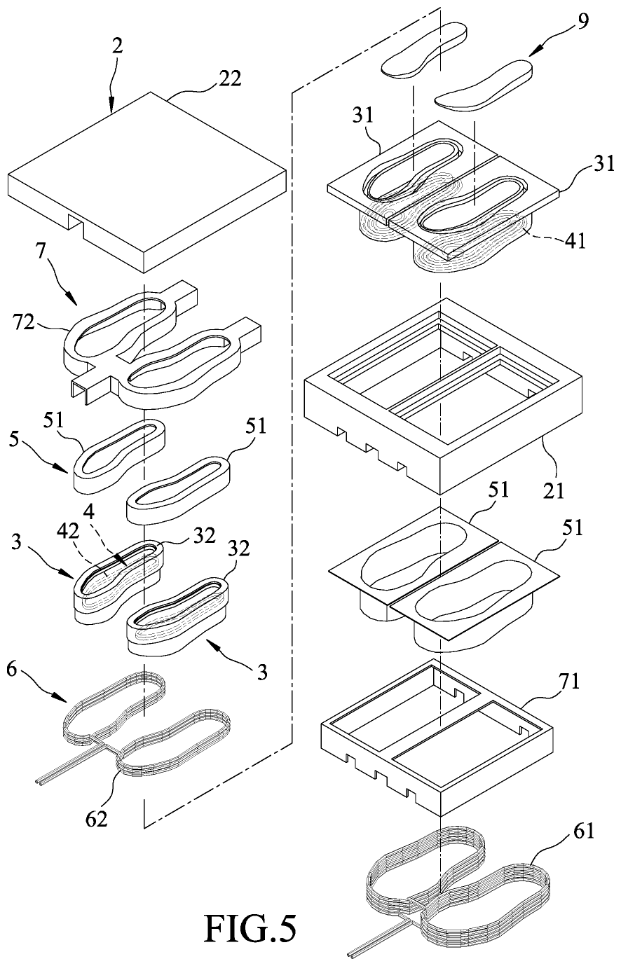

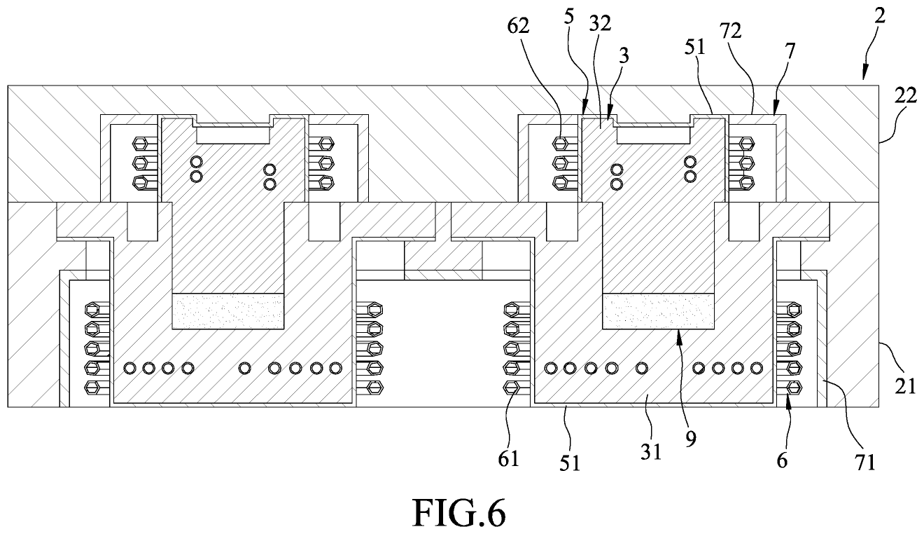

Referring to FIGS. 5 and 6, the third embodiment of the shoe sole molding device according to this disclosure is shown to be similar to the second embodiment, and differs from the second embodiment in that the induction heating unit 5 of the third embodiment includes four induction heating members 51, two for each core unit 3, and each of the induction heating members 51 is shaped as a box cover. It is noted that the number of the induction heating members 51 may be adjusted as required, and this disclosure is not limited in this respect. For each core unit 3, the two induction heating members 51 are sleeved on the lower core 31 and the upper core 32, respectively, and are disposed between the core unit 3 and the coil unit 6. Preferably, each of the induction heating members 51 has a small thickness and is shaped to fit a contour of the corresponding lower core 31 or upper core 32, so as to achieve better heat conduction.

In one implementation, the induction heating unit 5 may include only one induction heating member 51 that is configured and shaped to be sleeved on the lower cores 31 and the upper cores 32 of both the core units 3. Design of the induction heating unit 5 may be adjusted as required, and this disclosure is not limited in this respect.

The induction heating member 51 shaped as a box cover not only may have the functions as described in the first and second embodiments, but also may facilitate device assembly, thus promoting the production efficiency.

It should be appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A shoe sole molding device adapted for heating and molding a foamed material into a shoe sole, said shoe sole molding device comprising:
at least one mold seat unit (2) defining a core receiving space (23);
a core unit (3) disposed in said core receiving space (23) and defining a cavity (33) adapted for receiving the foamed material;
an induction heating unit (5) disposed around said core unit (3) , and having magnetic permeability greater than that of said core unit (3); and
a coil unit (6) disposed around said induction heating unit (5), and providing electromagnetic wave to induce heating in said induction heating unit (5) to heat up said core unit (3) and the foamed material.

2. The shoe sole molding device as claimed in claim 1, wherein said core unit (3) has thermal conductivity greater than that of said induction heating unit (5).

3. The shoe sole molding device as claimed in claim 1, further comprising a wave guiding unit (7) that is disposed between said at least one mold seat unit (2) and said coil unit (6) for directing the electromagnetic wave toward said core unit (3).

4. The shoe sole molding device as claimed in claim 3, wherein said wave guiding unit (7) is made of a soft magnetic material.

5. The shoe sole molding device as claimed in claim 1, wherein the magnetic permeability of said induction heating unit (5) is greater than that of said at least one mold seat unit (2).

6. The shoe sole molding device as claimed in claim 1, wherein said induction heating unit (5) further has a volume smaller than that of said core unit (3).

7. The shoe sole molding device as claimed in claim 1, wherein said induction heating unit (5) includes a plurality of induction heating members (51) that surround said core unit (3), each of said induction heating members (51) being one of bar-shaped and sheet-shaped.

8. The shoe sole molding device as claimed in claim 1, wherein said core unit (3) is removably received in said core receiving space (23).

9. The shoe sole molding device as claimed in claim 1, wherein the electromagnetic wave provided by said coil unit (6) is a high frequency electromagnetic wave.

10. The shoe sole molding device as claimed in claim 1, wherein:
said at least one mold seat unit (2) includes a lower mold seat (21) and an upper mold seat (22) that cooperatively define said core receiving space (23);
said core unit (3) includes a lower core (31) that is mounted to said lower mold seat (21) , and an upper core (32) that is mounted to said upper mold seat (22) and that cooperates with said lower core (31) to define said cavity (33);
said induction heating unit (5) includes at least two induction heating members (51) that respectively surround said lower core (31) and said upper core (32); and
said coil unit (6) includes a lower coil (61) that surrounds said lower core (31), and an upper coil (62) that surrounds said upper core (32).

11. The shoe sole molding device as claimed in claim 10, further comprising a temperature adjusting unit (4) that includes a lower temperature adjusting module (41) disposed in said lower core (31), and an upper temperature adj u sting module (42) disposed in said upper core (32).
